(19) United States
(12) Patent Application Publication
(10) Pub. No.: US 2004/0131318 A1
(43) Pub. Date: Jul. 8, 2004

(54) Optical element housing package and optical module

(75) Inventors: Ryuji Mori, Kokubu-shi (JP); Masaaki Miyahara, Kokubu-shi (JP); Seigo Matsuzono, Kokubu-shi (JP); Takashi Kimura, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/652,588

(22) Filed: Aug. 29, 2003

(30) Foreign Application Priority Data
Aug. 30, 2002 (JP) P2002-253862
Sep. 25, 2002 (JP) P2002-279129
Sep. 30, 2002 (JP) P2002-284609
Oct. 25, 2002 (JP) P2002-311833

(51) Int. Cl. G02B 6/36

(52) U.S. Cl. 385/92; 385/94

(57) ABSTRACT

An object of the invention is to provide an optical element housing package in which efficiency of coupling between a plurality of optical fibers and an optical element can be enhanced, and the optical element can be normally operated with stability for a longer period of time. The optical element housing package comprises: a base body having a placement portion formed on its top surface, on which an optical element is placed; and a frame body attached to the top surface of the base body so as to surround the placement portion, which has an optical fiber introducing portion formed in the upper part of its side surface. The optical fiber introducing portion is shaped as a groove having a substantially U-shaped sectional profile, through which an optical fiber is inserted and brazed. A lid body is brazed to the top surface of the frame body.

### BACKGROUND OF THE INVENTION

1. Field of the Invention

The present invention relates to an optical element housing package for housing therein a wavelength coupling/branching device for coupling or branching optical signals which are different in wavelength from each other, an optical passive device such as an optical switch, or an optical semiconductor device such as a laser diode (abbreviated as LD) or a photo diode (abbreviated as PD) (hereafter referred to as an “optical element”), and also to an optical module constituted by optically coupling the optical element housing package carrying an optical element to an optical fiber.

2. Description of the Related Art

Perspectively shown in FIG. 13 is an example of a conventional optical element housing package. Moreover, perspectively shown in FIG. 14 is an example of an optical module constituted by optically coupling the optical element housing package carrying an optical element such as a wavelength coupling/branching device to an optical fiber.

The optical element housing package is mainly composed of a base body 11, a frame body 12 and a pipe 13. The base body 11 includes a placement portion 11a on which an optical element 17 is placed, and a flange portion 11b which is formed at the outer periphery of the base body 11 so as to be secured by screws to an external electric circuit board (not shown). The optical element 17 is a wavelength coupling/branching device which couples or branches optical signals of different wavelengths, an optical passive device such as an optical switch, or an optical semiconductor device such as a laser diode (LD) and a photo diode (PD). The frame body 12, which is attached to the top surface of the base body 11 so as to surround the placement portion 11a, includes: an optical fiber introducing portion (hereafter referred to simply as the “introducing portion”) 12a, shaped as a through hole, formed at substantially the central position of each of the other opposed side surfaces of the frame body 12, for directing an optical fiber 18; and a pipe mounting portion (hereafter referred to simply as the “mounting portion”) 12b formed on the outer side surface of the frame body 12 opposite to the introducing portion 12a. The pipe 13, which is bonded so as to surround the mounting portion 12b, acts to direct the optical fiber 18 to the introducing portion 12a.

The optical module is realized as follows. On the top surface of the placement portion 11a are placed, via a support 15, the optical element 17 and an optical fiber alignment device (hereafter referred to simply as the “alignment device”) 16. The optical fiber 18 is directed from the pipe 13 to the optical element 17 through the introducing portion 12a, and is then moved forward and backward along a substantially V-shaped V groove 16a formed on the top surface of the alignment device 16. Thereby, the optical fiber 18 is optically coupled to the optical element 17. Upon completion of the optical coupling, a holder 13a is welded to the front-end surface of the pipe 13 through YAG laser welding, for example. Then, a lid body 19 is YAG-laser-welded or brazed to the top surface of the frame body 12. Thereupon, the optical module is realized in which the optical element housing package is hermetically sealed. The optical module which hermetically accommodates therein the optical element 17 is for use in high-speed optical communications or the like purposes.

Perspectively shown in FIG. 15 is an example of another conventional optical element housing package. Moreover, perspectively shown in FIG. 16 is an example of an optical module constituted by optically coupling the optical element housing package carrying an optical element such as a wavelength coupling/branching device to an optical fiber.

The optical element housing package is mainly composed of a base body 111, a frame body 112, a pipe 113, and an input/output terminal 114. The base body 111 includes a placement portion 111a on which an optical element 117 which is the same as the above-described is placed, and a flange portion 111b which is formed at the outer periphery of the base body 111 so as to be secured by screws to an external electric circuit board (not shown). The frame body 112, which is attached to the top surface of the base body 111 so as to surround the placement portion 111a, includes: an input/output terminal fitting portion (hereafter referred to simply as the “fitting portion”) 112a, shaped as a through hole or a notch, formed on each of the opposed side surfaces of the frame body 112; an optical fiber introducing portion (hereafter referred to simply as the “introducing portion”) 112c, shaped as a through hole, formed at substantially the central position of each of the other opposed side surfaces of the frame body 112, for directing an optical fiber 118; and a pipe mounting portion (hereafter referred to simply as the “mounting portion”) 112b formed on the outer side surface of the frame body 112 opposite to the introducing portion 112c. The pipe 113, which is bonded so as to surround the mounting portion 112b, acts to direct the optical fiber 118 to the introducing portion 112c. The input/output terminal 114, which is fitted in the fitting portion 112a, has a metallized layer 114a and an external lead 114b formed on the top surface thereof.

The optical module is realized as follows. On the top surface of the placement portion 111a are placed, via a support 115, the optical element 117 and an optical fiber alignment device (hereafter referred to simply as the “alignment device”) 116. The optical fiber 118 is directed from the pipe 113 to the optical element 117 through the introducing portion 112c, and is then moved forward and backward along a substantially V-shaped V groove 116a formed on the top surface of the alignment device 116. Thereby, the optical fiber 118 is optically coupled to the optical element 117. Upon completion of the optical coupling, a holder 113a is welded to the front-end surface of the pipe 113 through YAG laser welding, for example. Then, a lid body 119 is YAG-laser-welded or brazed to the top surface of the frame body 112. Thereupon, the optical module is realized in which the optical element housing package is hermetically sealed. The optical module which hermetically accommodates therein the optical element 117 is for use in high-speed optical communications or the like purposes.

Other conventional optical modules are disclosed in Unexamined Japanese Patent Publications JP-A 6-3566(1994), JP-A 7-198973(1995) and JP-A 2001-21818.

Although the optical module has succeeded in hermetically accommodating therein the optical element 17, 117 and has been used in high-speed optical communications or the like purposes, it suffers from the following drawbacks. Firstly, in order to achieve optical transmission of high-volume data, a plurality of optical fibers 18, 118 need to be inserted into the optical element housing package. In this case, the operation of directing a plurality of optical fibers 18, 118 into the optical element housing package, as well as the operation of optically coupling the optical fibers 18, 118 to the optical element 17, 117, is significantly complicated. More specifically, the V groove 16a, 116a of the alignment device 16, 116 is the only portion that can allow stable and secure placement of the optical fiber 18, 118. Therefore, in the case of using a plurality of optical fibers 18, 118 even if the first optical fiber 18, 118 can be optically coupled successfully, the optical coupling may possibly be deteriorated at the time when the other optical fiber 18, 118 is optically coupled, that is, the optical axis is undesirably deviated. It will thus be seen that it is extremely difficult to make all of the optical fibers 18, 118 coincide with one another in optical axis. Secondly, since the operations are significantly complicated, there is a high possibility that the optical fiber 18, 118 is broken during the operations.

Moreover, even if a plurality of optical fibers 18, 118 can be optically coupled to the optical element 17, 117 successfully, thereafter, the following two process steps are required: the holder 13a, 113a is YAG-laser-welded to the front-end surface of the pipe 13, 113; and the lid body 19, 119 is bonded to the top surface of the frame body 12, 112. Due to the thermal history occurring during the process, a stress is produced in an extent sufficient to deform the optical fiber 18, 118. This leads, albeit slight, to degradation in the optical coupling between the optical element 17, 117 and the optical fiber 18, 118.

Accordingly, the optical element housing package and the optical module of conventional design fail to achieve optical transmission of high-volume data due to the poor operability of the optical element 17, 117.

Assuming that employed as the optical element 117 in another conventional optical module is an AWG (Array Waveguide Grating) to be disposed on a piezoelectric element. In this case, the piezoelectric element exhibits a piezoelectric effect through application of a high-frequency current; wherefore a surface acoustic wave is generated. As a result of the interaction between the surface acoustic wave and light, the AWG is capable of providing a filter effect, so that coupling and branching of a multiplicity of wavelengths can be achieved. Moreover, the optical element 117, typified by the AWG, generally requires temperature compensation. Such an optical element 117 is temperature-compensated after a Peltier element or the like is mounted in the optical element housing package. In order to achieve driving power transmission for the piezoelectric or Peltier element required in the operation of the optical element 117, the optical element housing package necessitates the input/output terminal 114.

### SUMMARY OF THE INVENTION

The invention has been devised in view of the above-described problems with the conventional art, and accordingly its object is to provide an optical element housing package and an optical module in which efficiency of coupling between a plurality of optical fibers, not to mention a single optical fiber, and an optical element can be enhanced, and also the optical element can be normally operated with stability for a longer period of time.

The invention provides an optical element housing package comprising:

a base body having a placement portion formed on one surface thereof, on which an optical element is placed; and

a frame body attached to the one surface of the base body so as to surround the placement portion, the frame body having an optical fiber introducing portion formed in one end part of its side surface, the optical fiber introducing portion being shaped as a groove having a substantially U-shaped sectional profile, through which an optical fiber is inserted and brazed, wherein a lid body is brazed to one surface of the frame body.

According to the invention, the optical element housing package includes the base body and the frame body. The base body has the placement portion formed on the one surface thereof, on which an optical element is placed. The frame body, which is attached to the one surface of the base body so as to surround the placement portion, has the optical fiber introducing portion formed in the one end part of its side surface. The optical fiber introducing portion is shaped as a groove having a substantially U-shaped sectional profile. Through this optical fiber introducing portion, the optical fiber is inserted and brazed. The lid body is brazed to the one surface of the frame body. In this construction, in contrast to the conventional example, the optical fiber can be inserted into the optical element housing package without passing through a pipe. Moreover, the optical fiber is temporarily secured to the optical fiber introducing portion, and is thereby optically coupled to the optical element, placed within the package, with high accuracy. Hence, it is possible to achieve optical coupling between at least a single optical fiber and the optical element with considerably high efficiency. Besides, at least a single optical fiber can be securely retained with stability. Further, since the optical fiber is inserted through the optical fiber introducing portion formed in the one end part of the frame body before brazing, in contrast to the conventional example, the construction of the invention no longer requires the following two process steps: the lid body is YAG-laser-welded or brazed to the one surface of the frame body; and the optical fiber inserted via a pipe into the optical element housing package is subjected to welding such as YAG-laser-welding. Hence, hermetic sealing can be achieved between the optical fiber introducing portion and the optical fiber concurrently with the brazing of the lid body to the one surface of the frame body, exploiting one, common thermal history. This helps reduce the required number of thermal history application to only one, whereby making it possible to minimize stresses produced every time thermal history is applied, so that the optical fiber can be protected against distortion. Thereby, the efficiency of the coupling between a plurality of optical fibers and the optical element can be enhanced, and the optical element can be normally operated with stability for a longer period of time.

In the invention it is preferable that the optical element housing package further comprises an input/output terminal fitted in an input/output terminal fitting portion shaped as a through hole or a notch, the input/output terminal fitting portion being formed on the side of the frame body or in that part of the base body which is located inside the frame body.

According to the invention, the optical element housing package further comprises an input/output terminal fitted in an input/output terminal fitting portion shaped as a through hole or a notch, the input/output terminal fitting portion being formed on the side of the frame body or in that part of the base body which is located inside the frame body, so that another advantage can be obtained that there is additionally provided the input/output terminal fitted in the input/output terminal fitting portion. This makes it possible to achieve driving power transmission for a piezoelectric or Peltier element required in the operation of the optical element, or transmission of high-frequency signals satisfactorily. Thereby, the optical element can be normally operated with stability for a longer period of time.

In the invention it is preferable that the optical element housing package further comprises an input/output terminal conductor which is led from the placement portion to another surface opposed to the one surface of the base body.

It is preferable that the optical element is a wavelength coupling/branching device.

It is preferable that the input/output terminal conductor allows input and output of a high-frequency signal of 10 GHz or above.

According to the invention, the optical element housing package further comprises an input/output terminal conductor which is led from the placement portion to another surface opposed to the one surface of the base body. This makes it possible to achieve driving power transmission for a piezoelectric or Peltier element required in the operation of the optical element, or transmission of high-frequency signals satisfactorily. Thereby, the optical element can be normally operated with stability for a longer period of time. Note that, within the base body, a wiring line is formed so as to extend from the placement portion to the input/output terminal conductor. A material used to form the wiring line can be arbitrarily selected from among W (tungsten), Mo—Mn (molybdenum manganese), and the like. The width, length, and thickness of the wiring line can be arbitrarily adjusted by the screen printing method. Hence, in the case of using the input/output terminal conductor to do high-frequency-signal input and output, since the impedance of the entire wiring conductor can be adjusted properly, an insertion or reflection loss in a high-frequency signal of 10 GHz or above can be suppressed; wherefore a high-frequency signal of 10 GHz or above can be transmitted with a minimum transmission loss.

Accordingly the efficiency of the coupling between a plurality of optical fibers and the optical element can be enhanced, and the optical element can be normally operated with stability for a longer period of time. In addition to that, by providing the input/output terminal or the input/output terminal conductor, driving power transmission for a piezoelectric or Peltier element required in the operation of the optical element, or transmission of high-frequency signals can be achieved satisfactorily; wherefore a high-frequency signal of 10 GHz or above can be transmitted with a minimum transmission loss.

In the invention, it is preferable that the optical fiber introducing portion has an opening having a width in a range from r+5 μm to r+200 μm, and a depth in a range from r+5 μm to r+200 μm, in which r (μm) is a diameter of the optical fiber.

According to the optical element housing package embodying the invention, the optical fiber introducing portion has an opening having a width in a range from r+5 μm to r+200 μm, and a depth in a range from r+5 μm to r+200 μm, in which r (μm) is a diameter of the optical fiber. In this case, the following advantage can be gained. Air exists in the optical fiber introducing portion, and this air causes a void in the brazing filler material when the brazing filler material is melted to fill the gap between the outer circumferential surface of the optical fiber and the optical fiber introducing portion. In this regard, since the above-described configuration of the optical fiber introducing portion facilitates letting the trapped air escape, the outer circumferential surface of the optical fiber located on the optical fiber introducing portion can be substantially uniformly covered with the brazing filler material. This makes it possible to completely eliminate the occurrence of such a void in the brazing filler material, and to protect the optical fiber against breakage effectively. As a result, excellent hermeticity can be attained in the optical fiber introducing portion, and the optical element can be normally operated with stability for a longer period of time.

In the invention it is preferable that a thickness of the frame body is in a range from 0.7 mm to 1.8 mm.

According to the invention, the thickness of the frame body should preferably be kept in a range from 0.7 mm to 1.8 mm. If the thickness of the frame body is less than 0.7 mm, the optical fiber cannot be securely retained with stability. By contrast, if the depth dimension is greater than 1.8 mm, the following problem arises. Since the brazing area for securing and retaining the optical fiber becomes wider, after the brazing operation, an extremely high residual stress is produced in between the optical fiber and the optical fiber introducing portion 2a. Consequently, when an external force is applied to the optical fiber, in the optical fiber introducing portion 2a, the brazing filler material around the optical fiber tends to undergo mechanical breakage such as a crack. This makes it difficult to hermetically seal the optical element.

In the invention it is preferable that the part of the optical fiber which is located in the optical fiber introducing portion is exposed, and the bared core has its outer circumference coated with a plating film.

According to the invention, since the part of the optical fiber which is located in the optical fiber introducing portion is exposed, and the bared core has its outer circumference coated with a plating film, the outer circumferential surface of the optical fiber is brazed, through the plating films and the brazing filler material, to the optical fiber introducing portion and the lid body successfully, thus achieving hermetic sealing of the optical fiber introducing portion.

In the invention it is preferable that the frame body has an optical fiber supporting member bonded to the base body side surface thereof so as to be located below the optical fiber introducing portion.

According to the invention, the optical fiber supporting member is bonded to a side surface of the frame body of the optical element housing package so as to be located around the optical fiber introducing portion, so that, even if the optical fiber is moved upward, downward, leftward, or rightward to achieve for example screw-engagement of the optical module in finished form to an external circuit board, the resultant stress is prevented from being directly transmitted to the brazing filler material around the optical fiber and the optical fiber 8 itself in the optical fiber introducing portion, because the front end of the supporting member acts as a starting point of the optical fiber.

In the invention it is preferable that the lid body includes a flange portion which is bonded to the top surface of the optical fiber supporting member.

According to the invention, a flange portion is formed in the lid body so that the flange portion is bonded to the top surface of the supporting member. By so doing, for example, when the optical fiber is moved upward, the flange portion acts as a starting point of the optical fiber. As a result, in the optical module of the invention, the optical fiber can be supported with high reliability.

The invention provides an optical module comprising:

the optical element housing package embodying the invention;

an optical element placed on the placement portion;

an optical-fiber inserted through the optical fiber introducing portion and subjected to brazing; and

a lid body brazed to the one surface of the frame body, for hermetically sealing the optical element and the optical fiber introducing portion.

According to the invention, the optical module includes: the optical element housing package embodying the invention; the optical element placed on the placement portion; the optical fiber inserted through the optical fiber introducing portion and subjected to brazing; and the lid body brazed to the one surface of the frame body, for hermetically sealing the optical element and the optical fiber introducing portion. In contrast to the conventional example, the optical module of the invention no longer requires the following two process steps: the holder is YAG-laser-welded to the front-end surface of the pipe after a plurality of optical fibers are optically coupled to the optical element; and the lid body is bonded to the one surface of the frame body. Therefore, it never occurs that a stress is produced in an extent sufficient to deform the optical fiber due to the thermal history occurring at that time, and this leads to degradation in the optical coupling between the optical element and the optical fiber. Hence, in the optical module, the optical element can be operated satisfactorily; wherefore optical transmission of high-volume data can be achieved. Moreover, by providing the input/output terminal or the input/output terminal conductor, driving power transmission for a piezoelectric or Peltier element required in the operation of the optical element, or transmission of high-frequency signals can be achieved satisfactorily.

### BRIEF DESCRIPTION OF THE DRAWINGS

Other and further objects, features, and advantages of the invention will be more explicit from the following detailed description taken with reference to the drawings wherein:

FIG. 1 is a perspective view showing an optical element housing package according to a first embodiment of the invention;

FIG. 2 is a partly enlarged perspective view of the optical element housing package shown in FIG. 1, illustrating the periphery of the optical fiber introducing portion thereof;

FIG. 3 is a perspective view showing a first embodiment of optical module according to the invention;

FIG. 4 is a perspective view showing an optical element housing package according to a second embodiment of the invention;

FIG. 5 is a perspective view showing an optical module according a second embodiment of to the invention;

FIG. 6 is a perspective view showing an optical element housing package according to a third embodiment of the invention;

FIG. 7 is a partly enlarged perspective view of the optical element housing package shown in FIG. 6, illustrating the periphery of the optical fiber introducing portion thereof;

FIG. 8 is a perspective view showing an optical module according to a third embodiment of the invention;

FIG. 9 is a perspective view showing an optical element housing package according to a fourth embodiment of the invention;

FIG. 10 is a perspective view showing an optical module according to a fifth embodiment of the invention;

FIG. 11 is a perspective view showing an optical module according to a fourth embodiment of the invention;

FIG. 12 is a perspective view showing an optical element housing package according to a sixth embodiment of the invention;

FIG. 13 is a perspective view showing an example of a conventional optical element housing package; and

FIG. 14 is a perspective view showing an example of a conventional optical module.

FIG. 15 is a perspective view showing another example of a conventional optical element housing package; and

FIG. 16 is a perspective view showing another example of a conventional optical module.

### DETAILED DESCRIPTION OF THE PREFERRED EMBODIMENTS

Now referring to the drawings, preferred embodiments of the invention are described below.

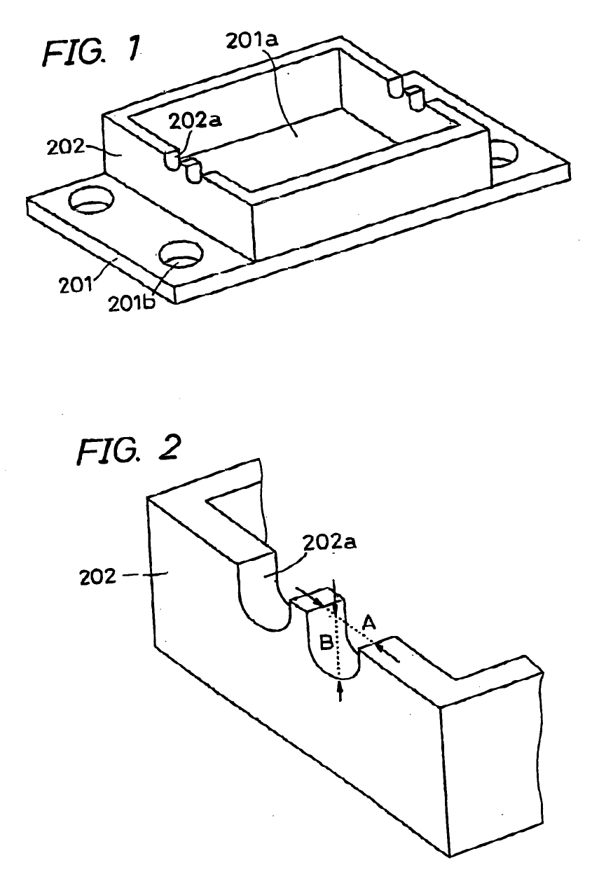

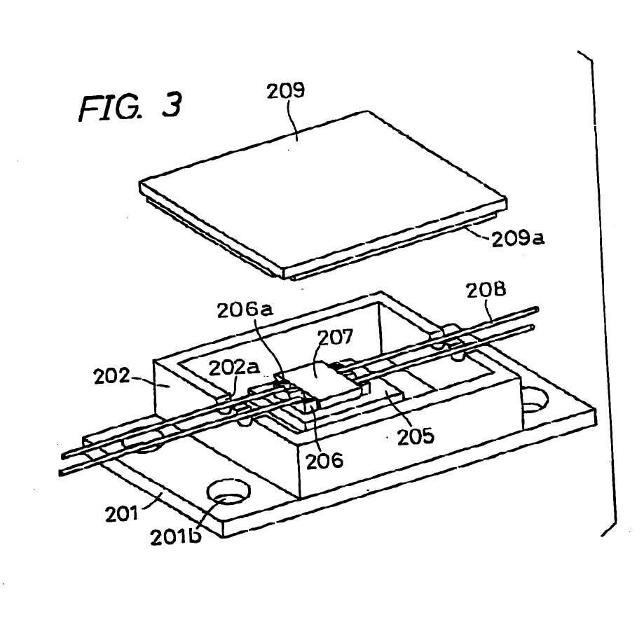

Hereinafter, the optical element housing package according to the invention will be described in detail. FIG. 1 is a perspective view showing an optical element housing package according to a first embodiment of the invention, and FIG. 2 is a partly enlarged perspective view showing the periphery of the optical fiber introducing portion of the optical element housing package.

In FIGS. 1 and 2, reference numeral 201 denotes a base body, and reference numeral 202 denotes a frame body. Basically, the base body 201 and the frame body 202 constitutes a casing for accommodating an optical element.

The base body 201 serves as a supporting member for supporting an optical element, and serves also as a substantially rectangular heat-dissipating plate for dissipating heat emitted from the optical element. The base body 201 has a placement portion 201a formed at substantially the central position of its top surface as one surface, on which the optical element is placed. Moreover, it is preferable that the base body 201 also has a flange portion 201b formed at the outer periphery thereof. The flange portion 201b is formed by extending part of the base body 201 outwardly of the frame body 202, and has a screw hole. This allows the base body 201 to be secured by screws to an external electric circuit board (not shown).

The base body 201 is a platy body made of a metal material such as an Iron (Fe)-Nickel (Ni)-Cobalt (Co) alloy or a copper (Cu)-Tungsten (W) alloy. For example, in the case of using the Fe—Ni—Co alloy, the base body 201 is fabricated in the desired shape by subjecting the Fe—Ni—Co alloy ingot to a known metal processing method, such as the rolling process or stamping process.

Note that it is preferable that the base body 201 has its surface coated with a metal material which is highly corrosion-resistant and exhibits excellent wettability with respect to a brazing filler material, specifically, a 0.5 to 9 μm-thick Ni layer and a 0.5 to 5 μm -thick Au layer, one by one by the plating method. This makes it possible to effectively protect the base body 201 against oxidative corrosion, and to ensure that the optical element and the frame body 202 are firmly bonded to the top surface of the base body 201 by the brazing filler material.

Moreover, on the top surface of the base body 201 is bondedly arranged the frame body 202, shaped into for example a rectangular frame, so as to surround the placement portion 201a on which the optical element is placed. Thereby, a space is created for accommodating the optical element inside the frame body 202.

The frame body 202 is, like the base body 201, made of a metal material, and has at least a single optical fiber introducing portion 202a shaped as a groove having a substantially U-shaped sectional profile. The optical fiber introducing portion 202a is formed at substantially the central position of the upper part as one end part of the side surface of the frame body 202, using the same processing method as adopted in the base body 201. Through this optical fiber introducing portion 202a, an optical fiber is inserted and brazed.

For example, in the case of using an Fe—Ni—Co alloy, the frame body 202 is fabricated in the desired shape by subjecting the Fe—Ni—Co alloy ingot to a known metal processing method, such as the rolling process or stamping process. The frame body 202 is bondedly attached to the base body 201 by brazing the bottom surface of the former to the top surface of the latter with a brazing filler material such as silver (Ag) brazing filler therebetween. The brazing filler material is formed as a preform having an adequate volume, and is laid on the top surface of the base body 201. Moreover, just as is the case with the base body 201, it is preferable that the frame body 202 has its surface coated with a 0.5 to 9 μm -thick Ni layer and a 0.5 to 5 μm -thick Au layer one by one by the plating method.

In the optical element housing package embodying the invention, the optical fiber introducing portion 202a is shaped as a groove having a substantially U-shaped sectional profile, through which at least a single optical fiber is inserted and brazed. The optical fiber introducing portion 202a acts to securely retain the optical fiber with stability. Moreover, in a case where the base body 201 is secured, at its flange portion 201b, to the external circuit board by screws, a stress is caused in the flange portion 201b by the screw-engagement, and the resultant stress is transmitted to the optical fiber. At this time, the optical fiber introducing portion 202a acts to minimize the stress. Further, the optical fiber introducing portion 202a is so configured that, when the optical fiber is inserted therethrough and fixed by brazing, the outer circumferential surface of the optical fiber can be substantially uniformly covered with the brazing filler material. Hence, the following advantage can be gained. In the optical fiber introducing portion 202a is present air, and this air causes a void in the brazing filler material when the brazing filler material is melted to fill the gap between the outer circumferential surface of the optical fiber and the optical fiber introducing portion 202a. The above-described configuration of the optical fiber introducing portion 202a facilitates letting the trapped air escape, thus completely eliminating the occurrence of such a void in the brazing filler material. As a result, excellent hermeticity can be attained in the optical fiber introducing portion 202a.

As shown in the partly enlarged perspective view of FIG. 2, it is preferable that, the optical fiber introducing portion 202a has an opening having a width A in a range from r+5 μm to r+200 μm, and a depth B in a range from r+5 μm to r+200 μm, in which r (μm) is a diameter of the optical fiber to be inserted through the optical fiber introducing portion 202a.

If the width A of the opening is less than r+5 μm, the outer circumferential surface of the optical fiber cannot be substantially uniformly covered with the brazing filler material, and thus there arises a possibility that a void occurs in the brazing filler material. This makes it impossible to attain excellent hermeticity in the optical fiber introducing portion 202a, leading to failure of hermetically sealing the optical element. By contrast, if the width A of the opening is greater than r+200 μm, the optical fiber cannot be readily secured at substantially the central position of the optical fiber introducing portion 202a with stability. Thus, in the optical fiber, the cross-sectional center point of its part located in the optical fiber introducing portion 202a is not positionally coincident with the cross-sectional center point of the other part fixedly placed in the V groove of the alignment device capable of adjusting the optical axis. The alignment device is placed via the support on the placement portion 201a along with the optical element. Due to the positional deviation, the optical fiber is subjected to a stress, leading to occurrence of breakage. As a result, the optical module employing the optical element housing package suffers from considerable deterioration in the reliability.

Moreover, if the depth B of the opening is less than r+5 μm, the outer circumferential surface of the optical fiber cannot be substantially uniformly covered with the brazing filler material, and thus there arises a possibility that a void occurs in the brazing filler material. This makes it impossible to achieve excellent hermeticity in the optical fiber introducing portion 202a, leading to failure of hermetically sealing the optical element. By contrast, if the depth B of the opening is greater than r+200 μm, the following problem arises. When the frame body 202 is bonded to the top surface of the base body 201, due to the difference in thermal expansion coefficient between them, the base body 201 and frame body 202 are warped or twisted, resulting in distortion. Then, when screw-engagement is performed, a stress is produced to correct for the distortion, and the resultant stress is transmitted from the base body 201 to the optical fiber 208 through the optical fiber introducing portion 202a of the frame body 202 and the brazing filler material. Hence, when the base body 201 is secured, at its flange portion 201b, to the external electric circuit board by screws, a stress which is strong in an extent sufficient to make the optical fiber vulnerable to breakage is transmitted from the base body 201 to the optical fiber 208 through the optical fiber introducing portion 202a and the brazing filler material. As a result, the optical module employing the optical element housing package suffers from considerable deterioration in the reliability.

Further, the depth dimension of the optical fiber introducing portion 202a, or equivalently the thickness of the frame body 202 should preferably be kept in a range from 0.7 mm to 1.8 mm. If the depth dimension is less than 0.7 mm, the optical fiber cannot be securely retained with stability. By contrast, if the depth dimension is greater than 1.8 mm, the following problem arises. Since the brazing area for securing and retaining the optical fiber becomes wider, after the brazing operation, an extremely high residual stress is produced in between the optical fiber and the optical fiber introducing portion 202a. Consequently, when an external force is applied to the optical fiber, in the optical fiber introducing portion 202a, the brazing filler material around the optical fiber tends to undergo mechanical breakage such as a crack. This makes it difficult to hermetically seal the optical element.

FIG. 3 is perspective view showing the optical module according to a first embodiment of the invention using the optical element housing package of the invention thus far described. The optical module is constructed as follows. On the top surface of the placement portion 201a are placed, via a support 205, an optical element 207 and an alignment device 206. The optical fiber 208 is inserted from outside into the optical fiber introducing portion 202a, is subjected to brazing, and is then directed to the optical element 207. Then, the end of the optical fiber 208 is placed in a substantially V-shaped V groove 206a formed on the top surface of the alignment device 206, and is then moved forward and backward along the V groove 206a. Thereby, the optical fiber 208 is optically coupled to the optical element 207. Subsequently, a lid body 209 is brazed to the top surface of the frame body 202 including the optical fiber introducing portion 202a. The lid body 209 has its under surface clad with a low-temperature brazing filler material 209a such as gold (Au)-tin (Sn) brazing filler. Thereupon, the optical module of the invention is realized in which the optical element housing package is hermetically sealed.

In the optical module, that part of the optical fiber 208 inserted through the optical fiber introducing portion 202a which is located in the optical fiber introducing portion 202a is coated with a protective film (such as resin). This protective film is stripped off to make the quarts glass (the core) of the optical fiber 208 exposed. The bared core of the optical fiber 208 has its entire outer circumference coated with plating films such as Ni and Au in succession. Thereby, the outer circumferential surface of the optical fiber 208 is brazed, through the plating films and the brazing filler material, to the optical fiber introducing portion 202a and the lid body 209 successfully, thus achieving hermetic sealing of the optical fiber introducing portion 202a. In contrast to the conventional optical module, the optical module of the invention no longer requires the two previously-described process steps: the holder is YAG-laser-welded to the front-end surface of the pipe after a plurality of optical fibers are optically coupled to the optical element; and the lid body is bonded to the top surface of the frame body. Therefore, it never occurs that a stress is produced in an extent sufficient to deform the optical fiber due to the thermal history occurring at that time, and this leads to degradation in the optical coupling between the optical element and the optical fiber. Hence, in the optical module, the optical element 207 can be operated satisfactorily; wherefore optical transmission of high-volume data can be achieved.

### EXAMPLE 1

In order to determine the width A and depth B of the opening of the optical fiber introducing portion 202a of the optical element housing package embodying the invention, the following experiment was conducted.

An optical element housing package as shown in FIG. 1 is fabricated as follows. At first, there is prepared a Cu—W alloy-made base body 201 of 42 mm long×20 mm wide×1 mm high. The base body 201 has a 37 mm-long and 16 mm-wide flange portion 1b having a screw hole 2.5 mm in diameter formed at each end of the outer periphery thereof. Then, a frame body 202 is bonded to the top surface of the base body 201 using Ag brazing filler. The frame body 202 is made of an Fe—Ni—Co alloy which is 32 mm long, 20 mm wide, 3.5 mm high, and 1 mm thick. The frame body 202 has, at substantially the central position of the upper part of each of its opposed side surfaces, 8 pieces of optical fiber introducing portions 202a each shaped as a groove having a substantially U-shaped sectional profile. That is, the optical fiber introducing portions 202a are formed in a total number of 16. The width A and depth B of the opening of the optical fiber introducing portion 202a are parameterized.

In the evaluative sample of the optical element housing package thus fabricated, as shown in FIG. 3, a support 205, an alignment device 206, and an optical element 207 are bonded to a placement portion 201a surroundedly formed on the top surface of the substrate 201, using a low-temperature brazing filler material such as tin (Sn)-lead (Pb) solder. Moreover, an optical fiber 208 is inserted through each of the optical fiber introducing portions 202a (8 pieces in one side, i.e., 16 pieces in total), thus achieving optical coupling between the optical fibers 208 and the optical element 207.

Next, by brazing the lid body 209, whose under surface is clad with the low-temperature Au—Sn brazing filler material 209a, to the top surface of the frame body 202 including the optical fiber introducing portions 202a, all of the optical fibers 208 are concurrently brazed to their corresponding optical fiber introducing portions 202a. Thereupon, a test sample of the optical module is fabricated. Note that, in the optical module sample, that part of the optical fiber 208 which is inserted through the optical fiber introducing portion 202a and subjected to brazing is coated with a protective film made of resin. This protective film is stripped off to make the quarts glass-made core of the optical fiber 208 exposed. The bared core has its entire outer circumferential surface coated with a 1 μm-thick Ni plating film and a 1 μm-thick Au plating film one by one. Thereby, the outer circumferential surface of the optical fiber 208 is brazed, through these plating films, to the optical fiber introducing portion 202a.

Then, evaluation was performed on each of the optical module samples thus fabricated in terms of a breakage of the optical fiber and hermeticity.

In regard to a breakage of the optical fiber, occurrence of a breakage or a crack in the optical fiber is confirmed by visually checking the optical module samples.

In regard to hermeticity, firstly, the optical module samples are each immersed in Flourinert-base highly volatile solution. Then, a gross leak test is carried out to check occurrence of bubbles in the solution. Based on the test results, a bubble-free sample is regarded as a conforming item, whereas a bubble-bearing sample is regarded as a nonconforming item. Further, samples acknowledged as conforming items as a result of the gross leak test are pressurized with He for two hours under the condition of 50N/cm², and are then subjected to an He leak test. Eventually, the samples are classified as conforming items or nonconforming items according to the amount of He detected. If the He leakage is equal to or less than 5×10⁻⁹ Pa m³/sec, the sample is acceptable. By contrast, if the He leakage is greater than 5×10⁻⁹ Pa m³/sec, the sample is defective.

As a result, as shown in Tables 1 and 2, the reliability of the optical module is found to be dependent mainly on the relationship among the diameter r of the optical fiber 208, the width A of the opening of the optical fiber introducing portion 202a, and the depth B of the opening of the optical fiber introducing portion 202a.

Listed in Table 1 are the test results obtained on the condition that the width A of the opening is varied while the depth B of the opening is kept constant. As seen from Table 1, when the width A of the opening is less than r+5 μm, a few out of 50 pieces of the optical module samples suffer from failure of hermeticity. When the width A of the opening is equivalent to r, 18 out of 50 pieces of the samples suffer from failure of hermeticity. The hermeticity failure is attributed to the outer circumferential surface of the optical fiber 208 being unevenly covered with the brazing filler material. Besides, a multiplicity of voids are identified in the brazing filler material. On the other hand, when the width A of the opening is greater than r+200 μm, some optical fibers 208 are broken. The breakage is attributed to the positional deviation occurring in the optical fiber 208, i.e., the cross-sectional center point of the part inserted and brazed in the optical fiber introducing portion 202a being not coincident with the cross-sectional center point of the other part fixedly placed in the V groove 206a. In other words, the optical fiber 208 cannot be brazed to substantially the central position of the optical fiber introducing portion 202a with high accuracy. By contrast, the samples embodying the invention, in which the width A of the opening is kept in a range from r+5 μm to r+200 μm, suffer from neither hermeticity failure nor optical fiber breakage.

TABLE 1

| Opening width A | Opening depth B | Evaluation results on optical |
|---|---|---|
| (μm) | (μm) | module reliability |
| r | r + 55 | 18 out of 50 suffer from |
| | | hermeticity failure |
| r + 5 | ↑ | OK |
| r + 10 | ↑ | OK |
| r + 25 | ↑ | OK |
| r + 65 | ↑ | OK |
| r + 105 | ↑ | OK |
| r + 145 | ↑ | OK |
| r + 165 | ↑ | OK |
| r + 175 | ↑ | OK |
| r + 195 | ↑ | OK |
| r + 200 | ↑ | OK |
| r + 205 | ↑ | 3 out of 50 suffer from optical |
| | | fiber breakage |
| r + 210 | ↑ | 5 out of 50 suffer from optical |
| | | fiber breakage |
| r + 220 | ↑ | 12 out of 50 suffer from optical |
| | | fiber breakage |

Listed in Table 2 are the test results obtained on the condition that the depth B of the opening is varied while the width A of the opening is kept constant. As seen from Table 2, when the depth B of the opening is less than r+5 μm, a few out of 50 pieces of the optical module samples suffer from failure of hermeticity. When the depth B of the opening is equivalent to r, 4 out of 50 pieces of the samples suffer from failure of hermeticity. The hermeticity failure is attributed to the outer circumferential surface of the optical fiber 208 being unevenly covered with the brazing filler material. Besides, a multiplicity of voids are identified in the brazing filler material. On the other hand, when the depth B of the opening is greater than r+200 μm, some optical fibers 208 are broken at the time of screw-engaging the optical module to a simple aluminum (Al)-made external circuit board of 50 mm long×30 mm wide×5 mm high via the flange portion 201b. This breakage is caused by the following reason. When the frame body 202 is bonded to the base body 201, due to the difference in thermal expansion coefficient between them, a warp or a twist appears in the base body 201, resulting in distortion. Then, when screw-engagement is performed, a force is produced to correct for the distortion, and the resultant force is transmitted from the base body 201 to the optical fiber 208 through the optical fiber introducing portion 202a of the frame body 202 and the brazing filler material. By contrast, the samples embodying the invention, in which the depth B of the opening is kept in a range from r+5 μm to r+200 μm, suffer from neither hermeticity failure nor optical fiber breakage.

TABLE 2

| Opening width A | Opening depth B | Evaluation results on optical |
|---|---|---|
| (μm) | (μm) | module reliability |
| r + 55 | r | 4 out of 50 suffer from |
| | | hermeticity failure |
| ↑ | r + 5 | OK |
| ↑ | r + 10 | OK |
| ↑ | r + 25 | OK |
| ↑ | r + 65 | OK |
| ↑ | r + 105 | OK |
| ↑ | r + 145 | OK |
| ↑ | r + 165 | OK |
| ↑ | r + 175 | OK |
| ↑ | r + 195 | OK |
| ↑ | r + 200 | OK |
| ↑ | r + 205 | 2 out of 50 suffer from optical |
| | | fiber breakage |
| ↑ | r + 210 | 5 out of 50 suffer from optical |
| | | fiber breakage |
| ↑ | r + 220 | 10 out of 50 suffer from optical |
| | | fiber breakage |

According to the test samples embodying the invention, it has been experimentally confirmed that, the optical fiber introducing portion 202a has the opening having the width A preferably in a range from r+5 μm to r+200 μm, and the depth B preferably in a range from r+5 μm to r+200 μm, in which r (μm) is a diameter of the optical fiber 208.

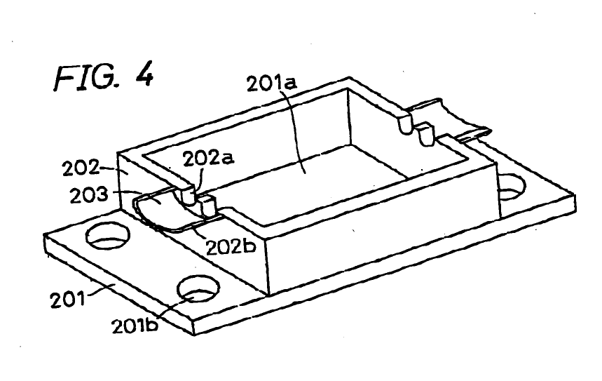

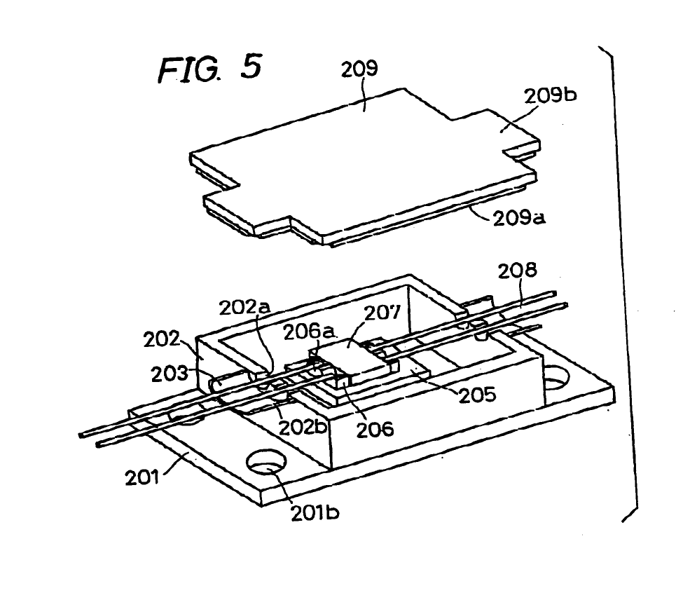

It is to be understood that the application of the invention is not limited to the specific embodiments described heretofore, and that many modifications and variations of the invention are possible within the spirit and scope of the invention. For example, as perspectively shown in FIG. 4, an optical fiber supporting member 203 may additionally be provided. The optical fiber supporting member 203 is bonded to an outer side surface 202b of the frame body 202 of the optical element housing package according to a second embodiment of the invention so as to be located around the optical fiber introducing portion 202a. FIG. 5 is a perspective view of the embodiment thereof. In this case, even if the optical fiber 208 is moved upward, downward, leftward, or rightward to achieve for example screw-engagement of the optical module in finished form to an external electric circuit board, since the front end of the supporting member 203 acts as a starting point of the optical fiber 208, in the optical fiber introducing portion 202a, the resultant stress is prevented from being directly transmitted to the brazing filler material around the optical fiber and the optical fiber 208 itself. Note that, in this case, as shown in FIG. 5, a flange portion 209b should preferably be formed in the lid body 209. The flange portion 209b is bonded to the top surface of the supporting member 203. By so doing, for example, when the optical fiber 208 is moved upward, the flange portion 209b acts as a starting point of the optical fiber 208. As a result, in the optical module of the invention, the optical fiber 208 can be supported with high reliability.

Moreover, in the embodiments thus far described, the frame body 202 has the optical fiber introducing portion 202a formed in each of the two opposed side portions thereof, and the base body 201 has the flange portion 201b formed at the outer periphery thereof on the side of the optical fiber introducing portion 202a. However, the arrangement of the flange portion 201b is not limited thereto, and thus the flange portion 201b may be arranged so as to extend from every corner of the frame body 2.

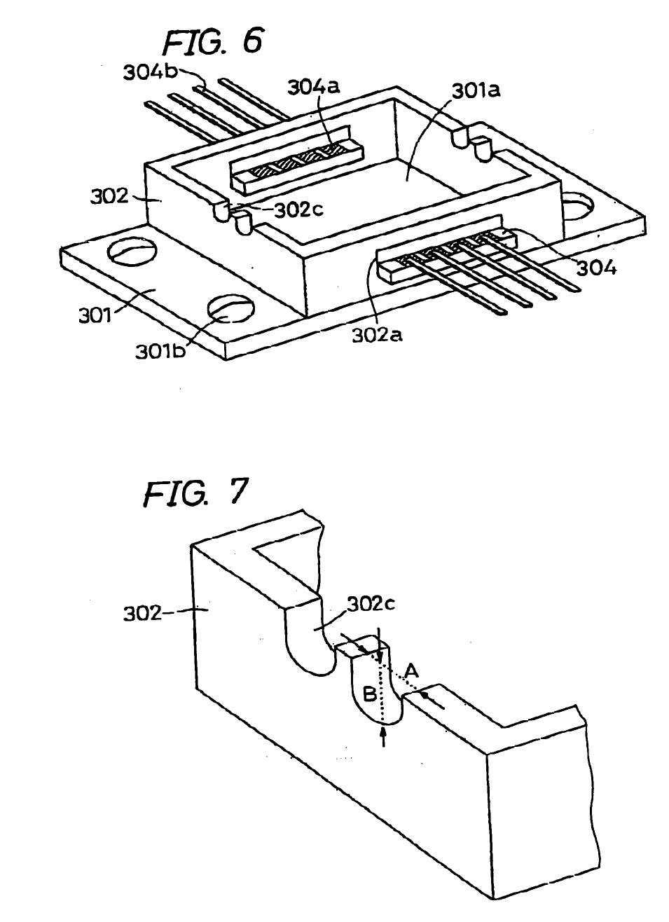

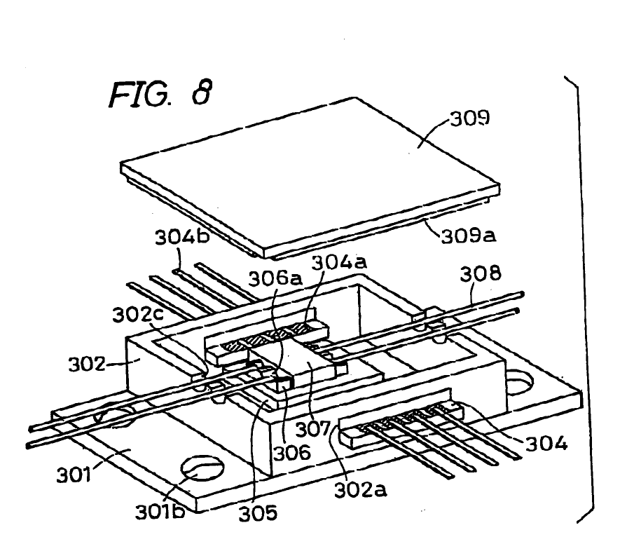

FIG. 6 is a perspective view showing an optical element housing package according to a third embodiment of the invention, and FIG. 7 is a partly enlarged perspective view showing the periphery of the optical fiber introducing portion of the optical element housing package.

In FIGS. 6 and 7, reference numeral 301 denotes a base body, reference numeral 302 denotes a frame body, and reference numeral 304 denotes an input/output terminal. Basically, the base body 301, the frame body 302, and the input/output terminal 304 constitutes a casing for accommodating an optical element.

The base body 301 serves as a supporting member for supporting an optical element, and serves also as a substantially rectangular heat-dissipating plate for dissipating heat emitted from the optical element, as the base body 201 of the above embodiment. The base body 301 has a placement portion 301a formed at substantially the central position of its top surface, on which the optical element is placed. Moreover, it is preferable that the base body 301 also has a flange portion 301b formed at the outer periphery thereof. The flange portion 301b is formed by extending part of the base body 301 outwardly of the frame body 302, and has a screw hole. This allows the base body 301 to be secured by screws to an external electric circuit board (not shown).

The base body 301 is a platy body made of the same material as that of the base body 201 of the above embodiment. For example, in the case of using the Fe—Ni—Co alloy, the base body 301 is fabricated in the desired shape by subjecting the Fe—Ni—Co alloy ingot to the same metal processing method as that of the base body 201 of the above embodiment.

To a surface of the base body 301, the same treatment as that of the base body 201 of the above embodiment is applied. The detailed description of the treatment will be omitted.

Moreover, on the top surface of the base body 301 is bondedly arranged the frame body 302, shaped into for example a rectangular frame, so as to surround the placement portion 301a on which the optical element is placed. Thereby, a space is created for accommodating the optical element inside the frame body 302.

The frame body 302 is, like the base body 301, made of a metal material, and has an input/output terminal fitting portion 302a formed at least one side surface thereof. The input/output terminal fitting portion 302a is shaped as a through hole or a notch, using the same processing method as adopted in the base body 301. Moreover, the frame body 302 has at least a single optical fiber introducing portion 302c shaped as a groove having a substantially U-shaped sectional profile. The optical fiber introducing portion 302c is formed at substantially the central position of the upper part of the other side surface of the frame body 302. Through this optical fiber introducing portion 302c, an optical fiber is inserted and brazed.

For example, in the case of using an Fe—Ni—Co alloy, the frame body 302 is fabricated in the desired shape by subjecting the Fe—Ni—Co alloy ingot to a conventionally known metal processing method the same as that of the frame body 202 of the above embodiment. The frame body 302 is bondedly attached to the base body 301 by the same method as that of the above embodiment. Moreover, just as is the case with the base body 301, it is preferable that the same treatment as that of the frame body 202 is applied to a surface of the frame body 302.

In the optical element housing package of the invention, the optical fiber introducing portion 302c is the same as that of the optical fiber introducing portion 202a, and the detailed description thereof will be omitted.

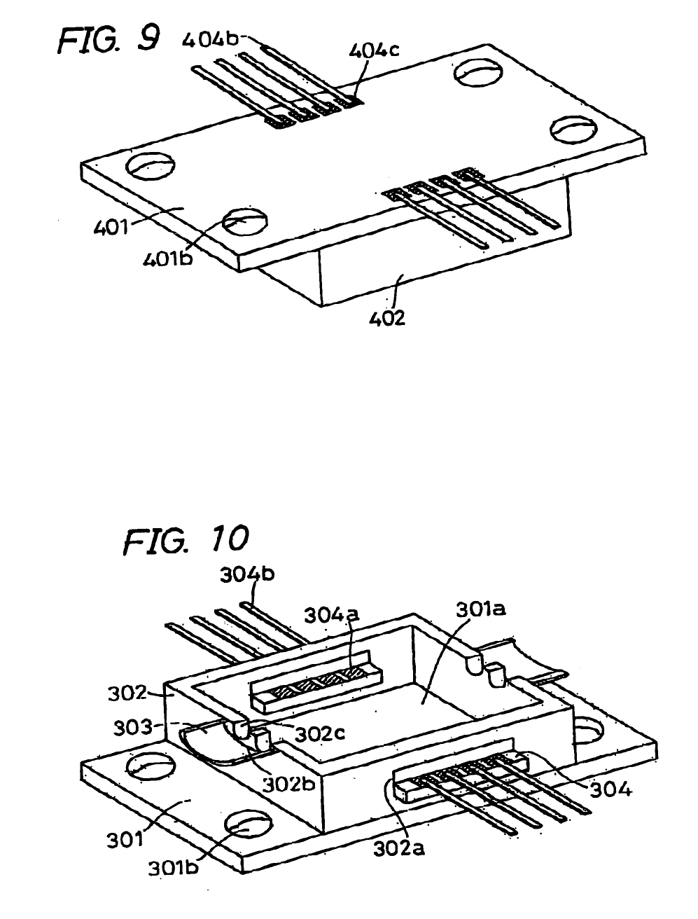

FIG. 9 is a perspective view showing an optical element housing package according to a fourth embodiment of the invention, as seen from the underside. In the figure, reference numeral 404c denotes an input/output terminal conductor, and reference numeral 404b denotes an external input/output terminal bonded to the input/output terminal conductor 404c.

It should be noted that the optical element housing package according to the fourth embodiment of the invention includes: a base body 401; a frame body 402; and the input/output terminal conductor 404c. The base body 401 has a placement portion 401a formed on the top surface thereof, on which an optical element is placed. The frame body 402, which is attached to the top surface of the base body 401 so as to surround the placement portion 401a, has an optical fiber introducing portion formed in the upper part of its side surface. The optical fiber introducing portion is shaped as a groove having a substantially U-shaped sectional profile. Through this optical fiber introducing portion, the optical fiber is inserted and brazed. Onto the top surface of the frame body 402 is brazed a lid body. The input/output terminal conductor 404c is led from the placement portion 401a to the bottom surface of the base body 401.

According to the invention, the optical element housing package according to the fourth embodiment of the invention includes: the base body 401; the frame body 402; and the input/output terminal conductor 404c. The base body 401 has the placement portion 401a formed on the top surface thereof, on which an optical element is placed. The frame body 402, which is attached to the top surface of the base body 401 so as to surround the placement portion 401a, has the optical fiber introducing portion formed in the upper part of its side surface. The optical fiber introducing portion is shaped as a groove having a substantially U-shaped sectional profile. Through this optical fiber introducing portion, the optical fiber is inserted and brazed. Onto the top surface of the frame body 402 is brazed the lid body. The input/output terminal conductor 404c is led from the placement portion 401a to the bottom surface of the base body 401. With this construction, the optical fiber is temporarily secured to the optical fiber introducing portion, and is thereby optically coupled to the optical element, placed within the package, with high accuracy. Hence, it is possible to achieve optical coupling between at least a single optical fiber and the optical element with considerably high efficiency. Besides, at least a single optical fiber can be securely retained with stability. Further, hermetic sealing can be achieved between the optical fiber introducing portion and the optical fiber concurrently with the brazing of the lid body to the top surface of the frame body 402, exploiting one, common thermal history. This helps reduce the required number of thermal history application to only one, whereby making it possible to minimize stresses produced every time thermal history is applied, so that the optical fiber can be protected against distortion.

Another advantage is that there is additionally provided the input/output terminal conductor 404c which is led from the placement portion 401a to the bottom surface of the base body 401. To achieve the leading of the input/output terminal conductor 404c, a wiring conductor is formed so as to extend from the placement portion la surroundedly formed on the base body 401 to the input/output terminal conductor 404c. A material used to form the wiring conductor can be arbitrarily selected from among W (tungsten), Mo—Mn (molybdenum manganese), and the like. Moreover, the width, length, and thickness of the wiring line can be arbitrarily adjusted by the screen printing method. Hence, not only it is possible to achieve driving power transmission for a piezoelectric or Peltier element required in the operation of the optical element or high-frequency signal transmission satisfactorily, but it is also possible to adjust the impedance of the entire wiring conductor to a desired value. As a result, an insertion or reflection loss in a high-frequency signal of 10 GHz or above can be suppressed; wherefore a high-frequency signal of 10 GHz or above can be transmitted with a minimum transmission loss.

Thereby, the efficiency of the coupling between a plurality of optical fibers and the optical element can be enhanced, and the optical element can be normally operated with stability for a longer period of time. In addition to that, driving power transmission for a piezoelectric or Peltier element required in the operation of the optical element, or transmission of a high-frequency signal of 10 GHz or above can be achieved with a minimum transmission loss.

As shown in the partly enlarged perspective view of FIG. 7, it is preferable that, the optical fiber introducing portion 302c has an opening having a width A in a range from r+5 μm to r+200 μm, and a depth B in a range from r+5 μm to r+200 μm, in which r (μm) is a diameter of the optical fiber to be inserted through the optical fiber introducing portion 302c, for the same reason as that of the optical fiber introducing portion 202a of the above embodiment.

Further, the depth dimension of the optical fiber introducing portion 302c, or equivalently the thickness of the frame body 302 should preferably be kept in a range from 0.7 mm to 1.8 mm, for the same reason as that of the above embodiment.

Moreover, in the input/output terminal fitting portion 302a of the frame body 302 is fitted the input/output terminal 304 for providing electrical connection between the inner part of the optical element housing package and the external electric circuit board. The input/output terminal 304 is used to achieve driving power transmission for a piezoelectric or Peltier element, for example. In the case of employing the piezoelectric element, an AWG (Array Waveguide Grating), acting as the optical element, is disposed on the piezoelectric element. Through application of a high-frequency current, the piezoelectric element exhibits a piezoelectric effect; wherefore a surface acoustic wave is generated. As a result of the interaction between the surface acoustic wave and light, the AWG is capable of providing a filter effect, so that coupling and branching of a multiplicity of wavelengths can be achieved. In the case of employing the Peltier element, since the optical element such as the AWG requires temperature compensation, the Peltier element is mounted within the optical element housing package so as to perform temperature compensation on the optical element. As seen from the foregoing, the piezoelectric element, the Peltier element, or the like is necessary to operate the optical element normally, and thus the input/output terminal 304 is required to achieve driving power transmission for such an element and high-frequency signal transmission.

As shown in FIG. 6, for example, the input/output terminal 304 is composed of a flat plate portion and an upright wall portion. The flat plate portion is made of a prismatic dielectric plate, on which a plurality of metallized layers 304a are formed so as to conduct internally and externally of the frame body 302. The metallized layers 304a act as line conductors for transmitting high-frequency signals and also as ground conductors having grounding capability. The upright wall portion, which is made of a substantially prismatic dielectric plate, is bonded to the top surface of the flat plate portion, with the metallized layers 304a sandwiched therebetween. The upright wall portion is formed so as for the frame body 302 to be shut off externally. By connecting the metallized layers 304a formed on the top surface of the flat plate portion to the optical element with a bonding wire, etc. (not shown), a high-frequency signal can be inputted to and outputted from the optical element. A dielectric material used to form the flat plate portion and the upright wall portion is selected in consideration of the characteristics requirements such as a dielectric constant and a thermal expansion coefficient. The preferred examples thereof include alumina (Al₂O₃) ceramics and aluminum nitride (AlN) ceramics.

The input/output terminal 304 is fabricated as follows. Firstly, an organic composition or solvent is mixedly added to powder of tungsten (W), molybdenum (Mo), or manganese (Mn) which is formed into the metallized layer 304a, so as to obtain a metal paste. With the metal paste, a suitable organic binder or solvent is mixedly added to powder of a starting material which is formed into the flat plate portion and the upright wall portion. The paste thus obtained is print-coated, in a predetermined configuration, onto a ceramic green sheet formed by the doctor blade method or calendar roll method, using the conventionally-known screen printing method, followed by firing at a high temperature of approximately 1600° C.

Moreover, the external input/output terminal 304b is bonded, through a brazing filler material such as Ag brazing filler, to the top surface of the metallized layer 304a located outside the frame body 302. The external input/output terminal 304b serves to provide electrical connection between the optical element housing package and the external electric circuit board. To ensure that the external input/output terminal 304b is firmly bonded to the input/output terminal 304, a metal material used to form the former should preferably be similar in thermal expansion coefficient to a metal material used to form the latter. For example, in the case of using Al₂O₃ ceramics to form the flat plate portion of the input/output terminal 304, the external input/output terminal 304b is made of a Fe—Ni—Co alloy or Fe—Ni alloy.

FIG. 8 is perspective view showing the optical module according to a third embodiment of the invention using the optical element housing package of the invention thus far described. The optical module is constructed as follows. On the top surface of the placement portion 301a are placed, via a support 305, an optical element 307 and an alignment device 306. The optical fiber 308 is inserted from outside into the optical fiber introducing portion 302c, is subjected to brazing, and is then directed to the optical element 307. Then, the end of the optical fiber 308 is placed in a substantially V-shaped V groove 306a formed on the top surface of the alignment device 306, and is then moved forward and backward along the V groove 306a. Thereby, the optical fiber 308 is optically coupled to the optical element 307. Subsequently, a lid body 309 is brazed to the top surface of the frame body 302 including the optical fiber introducing portion 302c. The lid body 309 has its under surface clad with a low-temperature brazing filler material 309a such as gold (Au)-tin (Sn) brazing filler. Thereupon, the optical module of the invention is realized in which the optical element housing package is hermetically sealed.

In the optical module, as the above embodiment, that part of the optical fiber 308 inserted through the optical fiber introducing portion 302c which is located in the optical fiber introducing portion 302c is coated with a protective film (such as resin). This protective film is stripped off to make the quarts glass (the core) of the optical fiber 308 exposed. The bared core of the optical fiber 308 has its entire outer circumference coated with plating films such as Ni and Au in succession. Thereby, the outer circumferential surface of the optical fiber 308 is brazed, through the plating films and the brazing filler material, to the optical fiber introducing portion 302c and the lid body 309 successfully, thus achieving hermetic sealing of the optical fiber introducing portion 302c. In contrast to the conventional optical module, the optical module of the invention no longer requires the two previously-described process steps: the holder is YAG-laser-welded to the front-end surface of the pipe after a plurality of optical fibers are optically coupled to the optical element; and the lid body is bonded to the top surface of the frame body. Therefore, it never occurs that a stress is produced in an extent sufficient to deform the optical fiber due to the thermal history occurring at that time, and this leads to degradation in the optical coupling between the optical element and the optical fiber. Hence, in the optical module, the optical element 307 can be operated satisfactorily; wherefore optical transmission of high-volume data can be achieved.

Note that the optical module of the invention may also be constructed, using the optical element housing package according to the fourth embodiment of the invention shown in FIG. 9, basically in the same manner as in FIG. 8.

### EXAMPLE 2

In order to determine the width A and depth B of the opening of the optical fiber introducing portion 302c of the optical element housing package embodying the invention, the following experiment was conducted.

An optical element housing package as shown in FIG. 5 is fabricated as follows. At first, there is prepared a Cu—W alloy-made base body 1 of 42 mm long×20 mm wide×1 mm high. The base body 1 has a 37 mm-long and 16 mm-wide flange portion 1b having a screw hole 2.5 mm in diameter formed at each end of the outer periphery thereof. Then, a frame body 302 is bonded to the top surface of the base body 301 using Ag brazing filler. The frame body 302 is made of an Fe—Ni—Co alloy which is 32 mm long, 20 mm wide, 3.5 mm high, and 1 mm thick. The frame body 302 has, on each of its opposed side surfaces, an input/output terminal fitting portion 302a formed as a through hole, and also has, at substantially the central position of the upper part of each of its other opposed side surfaces, 8 pieces of optical fiber introducing portions 302c each shaped as a groove having a substantially U-shaped sectional profile. That is, the optical fiber introducing portions 302c are formed in a total number of 16. The width A and depth B of the opening of the optical fiber introducing portion 302c are parameterized. Moreover, an input/output terminal 304 is fitted in the input/output terminal fitting portion 302a with Ag brazing filler. The input/output terminal 304 is made of Al₂O₃ ceramics, and includes a flat plate portion, an upright wall portion, and metallized layers 304a.

Note that, in this example, since the purpose of mounting the input/output terminal 404 is not to establish electrical connection with the external electric circuit board but to evaluate the reliability of the optical module as observed in the optical fiber introducing portions 402c through experiments, no external input/output terminal 404b is disposed.

As the above example 1, in the evaluative sample of the optical element housing package thus fabricated, as shown in FIG. 8, the support 305, the alignment device 306, and the optical element 307 are bonded to the placement portion 301a surroundedly formed on the top surface of the substrate 301, using a low-temperature brazing filler material such as tin (Sn)-lead (Pb) solder. Moreover, the optical fiber 308 is inserted through each of the optical fiber introducing portions 302c (8 pieces in one side, i.e., 16 pieces in total), thus achieving optical coupling between the optical fibers 308 and the optical element 307.

Next, by brazing the lid body 309, whose under surface is clad with the low-temperature Au—Sn brazing filler material 309a, to the top surface of the frame body 302 including the optical fiber introducing portions 302c, all of the optical fibers 308 are concurrently brazed to their corresponding optical fiber introducing portions 302c. Thereupon, a test sample of the optical module is fabricated. Note that, in the optical module sample, that part of the optical fiber 308 which is inserted through the optical fiber introducing portion 302c and subjected to brazing is coated with a protective film made of resin. This protective film is stripped off to make the quarts glass-made core of the optical fiber 308 exposed. The bared core has its entire outer circumferential surface coated with a 1 μm-thick Ni plating film and a 1 μm-thick Au plating film one by one. Thereby, the outer circumferential surface of the optical fiber 308 is brazed, through these plating films, to the optical fiber introducing portion 302c.

Then, evaluation was performed on each of the optical module samples thus fabricated in terms of a breakage of the optical fiber and hermeticity.

In regard to a breakage of the optical fiber, occurrence of a breakage or a crack in the optical fiber is confirmed by visually checking the optical module samples.

In regard to hermeticity, firstly, the optical module samples are each immersed in Flourinert-base highly volatile solution. Then, a gross leak test is carried out to check occurrence of bubbles in the solution. Based on the test results, a bubble-free sample is regarded as a conforming item, whereas a bubble-bearing sample is regarded as a nonconforming item. Further, samples acknowledged as conforming items as a result of the gross leak test are pressurized with He for two hours under the condition of 50N/cm²₁ and are then subjected to an He leak test. Eventually, the samples are classified as conforming items or nonconforming items according to the amount of He detected. If the He leakage is equal to or less than 5×10⁻⁹ Pa·m³/sec, the sample is acceptable. By contrast, if the He leakage is greater than 5×10⁻⁹ Pa·m³/sec, the sample is defective.

As a result, as shown in Tables 3 and 4, the reliability of the optical module is found to be dependent mainly on the relationship among the diameter r of the optical fiber 308, the width A of the opening of the optical fiber introducing portion 302c, and the depth B of the opening of the optical fiber introducing portion 302c.

Listed in Table 3 are the test results obtained on the condition that the width A of the opening is varied while the depth B of the opening is kept constant. As seen from Table 1, when the width A of the opening is less than r+5 μm, a few out of 50 pieces of the optical module samples suffer from failure of hermeticity. When the width A of the opening is equivalent to r, 18 out of 50 pieces of the samples suffer from failure of hermeticity. The hermeticity failure is attributed to the outer circumferential surface of the optical fiber 308 being unevenly covered with the brazing filler material. Besides, a multiplicity of voids are identified in the brazing filler material. On the other hand, when the width A of the opening is greater than r+200 μm, some optical fibers 308 are broken. The breakage is attributed to the positional deviation occurring in the optical fiber 308, i.e., the cross-sectional center point of the part inserted and brazed in the optical fiber introducing portion 302c being not coincident with the cross-sectional center point of the other part fixedly placed in the V groove 306a. In other words, the optical fiber 308 cannot be brazed to substantially the central position of the optical fiber introducing portion 302c with high accuracy. By contrast, the samples embodying the invention, in which the width A of the opening is kept in a range from r+5 μm to r+200 μm, suffer from neither hermeticity failure nor optical fiber breakage.

TABLE 3

| Opening width A | Opening depth B | Evaluation results on optical |
|---|---|---|
| (μm) | (μm) | module reliability |
| r | r + 55 | 18 out of 50 suffer from |
| | | hermeticity failure |
| r + 5 | ↑ | OK |
| r + 10 | ↑ | OK |
| r + 25 | ↑ | OK |
| r + 65 | ↑ | OK |
| r + 105 | ↑ | OK |
| r + 145 | ↑ | OK |
| r + 165 | ↑ | OK |
| r + 175 | ↑ | OK |
| r + 195 | ↑ | OK |
| r + 200 | ↑ | OK |
| r + 205 | ↑ | 3 out of 50 suffer from optical |
| | | fiber breakage |
| r + 210 | ↑ | 5 out of 50 suffer from optical |
| | | fiber breakage |
| r + 220 | ↑ | 12 out of 50 suffer from optical |
| | | fiber breakage |

Listed in Table 4 are the test results obtained on the condition that the depth B of the opening is varied while the width A of the opening is kept constant. As seen from Table 4, when the depth B of the opening is less than r+5 μm, a few out of 50 pieces of the optical module samples suffer from failure of hermeticity. When the depth B of the opening is equivalent to r, 4 out of 50 pieces of the samples suffer from failure of hermeticity. The hermeticity failure is attributed to the outer circumferential surface of the optical fiber 308 being unevenly covered with the brazing filler material. Besides, a multiplicity of voids are identified in the brazing filler material. On the other hand, when the depth B of the opening is greater than r+200 μm, some optical fibers 308 are broken at the time of screw-engaging the optical module to a simple aluminum (Al)-made external electric circuit board of 50 mm long×30 mm wide×5 mm high via the flange portion 301b. This breakage is caused by the following reason. When the frame body 302 is bonded to the base body 301, due to the difference in thermal expansion coefficient between them, a warp or a twist appears in the base body 301, resulting in distortion. Then, when screw-engagement is performed, a force is produced to correct for the distortion, and the resultant force is transmitted from the base body 301 to the optical fiber 308 through the optical fiber introducing portion 302c of the frame body 302 and the brazing filler material. By contrast, the samples embodying the invention, in which the depth B of the opening is kept in a range from r+5 μm to r+200 μm, suffer from neither hermeticity failure nor optical fiber breakage.

TABLE 4

| Opening width A | Opening depth B | Evaluation results on optical |
|---|---|---|
| (μm) | (μm) | module reliability |
| r + 55 | r | 4 out of 50 suffer from |
| | | hermeticity failure |
| ↑ | r + 5 | OK |
| ↑ | r + 10 | OK |
| ↑ | r + 25 | OK |
| ↑ | r + 65 | OK |
| ↑ | r + 105 | OK |
| ↑ | r + 145 | OK |
| ↑ | r + 165 | OK |
| ↑ | r + 175 | OK |
| ↑ | r + 195 | OK |
| ↑ | r + 200 | OK |
| ↑ | r + 205 | 2 out of 50 suffer from optical |
| | | fiber breakage |
| ↑ | r + 210 | 5 out of 50 suffer from optical |
| | | fiber breakage |
| ↑ | r + 220 | 10 out of 50 suffer from optical |
| | | fiber breakage |

According to the test samples embodying the invention, it has been experimentally confirmed that, the optical fiber introducing portion 302c has the opening having the width A preferably in a range from r+5 μm to r+200 μm, and the depth B preferably in a range from r+5 μm to r+200 μm, in which r (μm) is the diameter of the optical fiber 308.

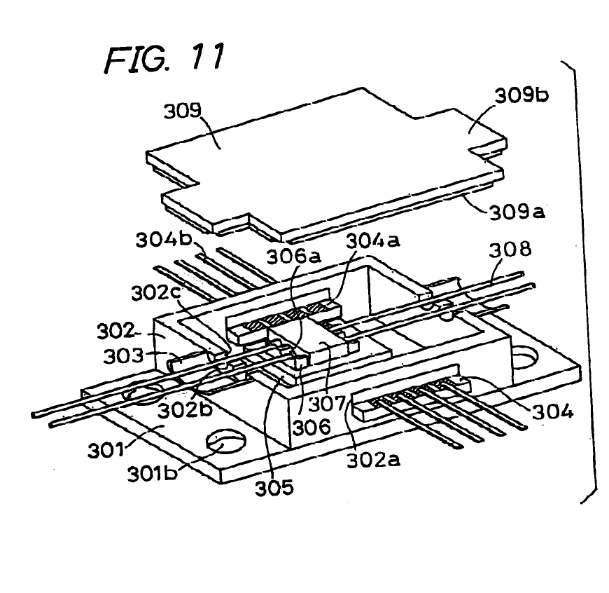

It is to be understood that the application of the invention is not limited to the specific embodiments described heretofore, and that many modifications and variations of the invention are possible within the spirit and scope of the invention. For example, as perspectively shown in FIG. 10, an optical fiber supporting member 303 may additionally be provided. The optical fiber supporting member 303 is bonded to an outer side surface 302b of the frame body 302 of the optical element housing package according to a fifth embodiment of the invention so as to be located around the optical fiber introducing portion 302c. FIG. 11 is a perspective view of the embodiment. In this case, even if the optical fiber 308 is moved upward, downward, leftward, or rightward to achieve for example screw-engagement of the optical module in finished form to the external electric circuit board, since the front end of the supporting member 303 acts as a starting point of the optical fiber 308, in the optical fiber introducing portion 302c, the resultant stress is prevented from being directly transmitted to the brazing filler material around the optical fiber and the optical fiber 308 itself. Note that, in this case, as shown in FIG. 11, a flange portion 309b should preferably be formed in the lid body 309. The flange portion 309b is bonded to the top surface of the supporting member 303. By so doing, for example, when the optical fiber 308 is moved upward, the flange portion 309b acts as a starting point of the optical fiber 308. As a result, in the optical module of the invention, the optical fiber 308 can be supported with high reliability.

Moreover, in the embodiments thus far described, the frame body 302 has the optical fiber introducing portion 302c formed in each of the two opposed side portions thereof, and the base body 301 has the flange portion 301b formed at the outer periphery thereof on the side of the optical fiber introducing portion 302c. However, the arrangement of the flange portion 301b is not limited thereto. For example, the flange portion 301b may be arranged at the outer periphery of the base body 301 on the side of the input/output terminal fitting portion 302a, or arranged so as to extend from every corner of the frame body 302.

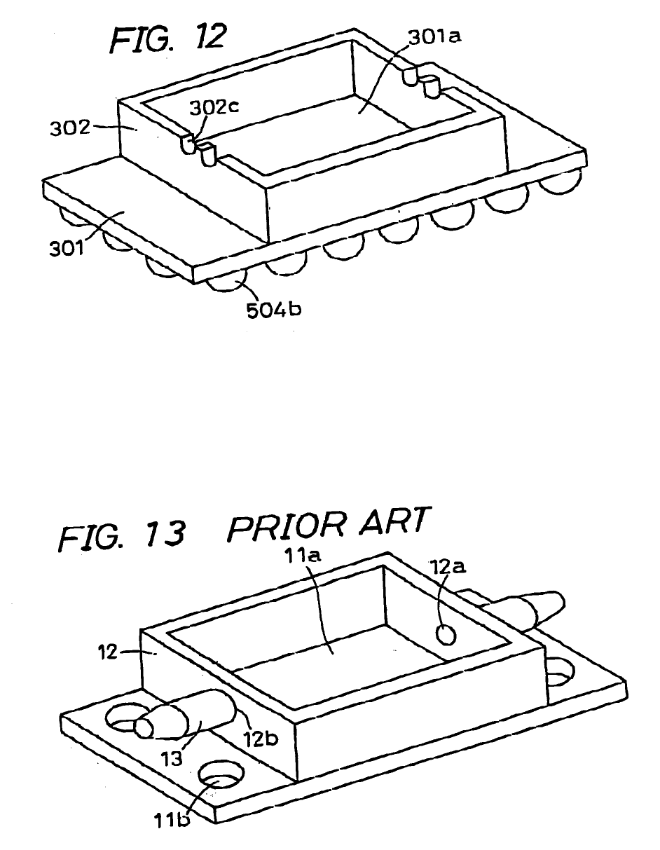

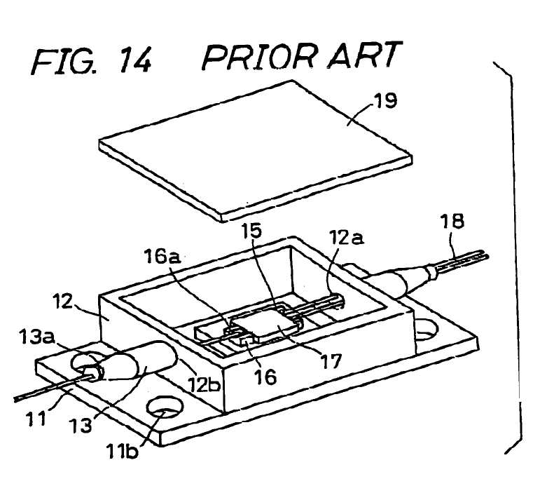

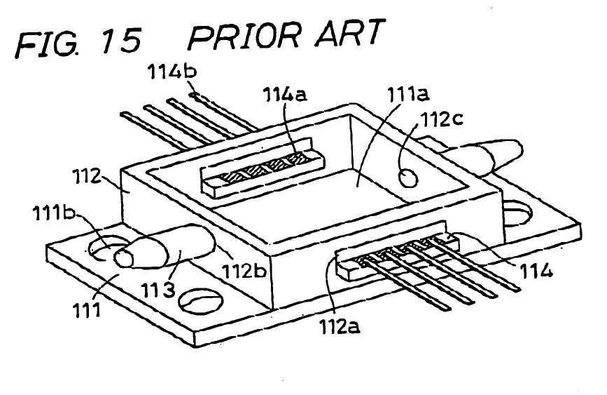

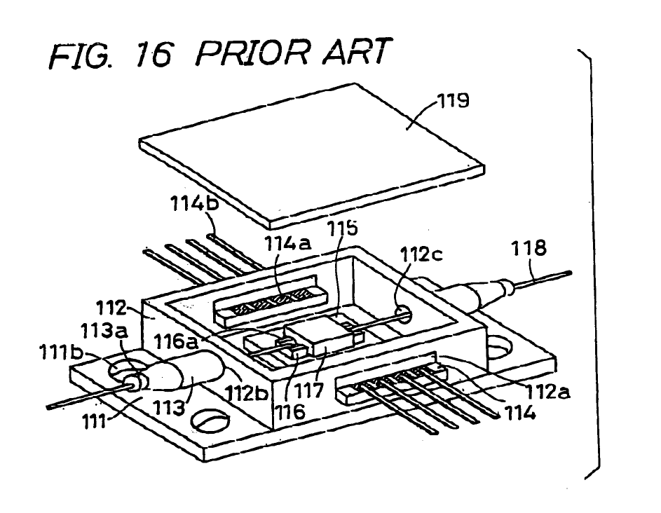

Further, in the embodiments thus far described, the external input/output terminal 404b is bonded to the input/output terminal conductor 404c with the brazing filler material. However, modifications can be made in this regard depending on the uses of the construction. For example, as shown in FIG. 12, the external input/output terminal 504b may be ball-shaped (BGA: Ball Grid Array type), or, the input/output terminal conductor 404c may be bonded directly to the external electric circuit board, using a brazing filler material such as solder, without the interposition of the external input/output terminal 404b (LGA: Land Grid Array type).

In the embodiments mentioned above, the optical element 207 and 307 is the wavelength coupling/branching device which is the array waveguide grating (AWG). Instead, the optical element 207 and 307 may be an optical passive device such as an optical switch. Further, the optical element 207 and 307 may be an optical semiconductor device such as a laser diode and a photo diode. Even if these optical elements are used in the optical element housing package according to the embodiment of the invention, the same result was obtained.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical element housing package, comprising:
a base body having a placement portion formed on one surface thereof, on which an optical element is placed; and
I,a frame body attached to the one surface of the base body so as to surround the placement portion, the frame body having an optical fiber introducing portion formed in one end part of its side surface, the optical fiber introducing portion being shaped as a groove having a substantially U-shaped sectional profile, through which an optical fiber is inserted and brazed, wherein a lid body is brazed to one surface of the frame body.

2. The optical element housing package of claim 1, further comprising:
an input/output terminal fitted in an input/output terminal fitting portion shaped as a through hole or a notch, the input/output terminal fitting portion being formed on the side of the frame body or in that part of the base body which is located inside the frame body.

3. The optical element housing package of claim 1, further comprising:
an input/output terminal conductor which is led from the placement portion to another surface opposed to the one surface of the base body.

4. The optical element housing package of claim 3, wherein the optical element is a wavelength coupling/branching device.

5. The optical element housing package of claim 3, wherein the input/output terminal conductor allows input and output of a high-frequency signal of 10 GHz or above.

6. The optical element housing package of claim 4, wherein the input/output terminal conductor allows input and output of a high-frequency signal of 10 GHz or above.

7. The optical element housing package of claim 1, wherein the optical fiber introducing portion has an opening having a width in a range from r+5 μm to r+200 μm, and a depth in a range from r+5 μm to r+200 μm, in which r (μm) is a diameter of the optical fiber.

8. The optical element housing package of claim 2, wherein the optical fiber introducing portion has an opening having a width in a range from r+5 μm to r+200 μm, and a depth in a range from r+5 μm to r+200 μm, in which r (μm) is a diameter of the optical fiber.

9. The optical element housing package of claim 3, wherein the optical fiber introducing portion has an opening having a width in a range from r+5 μm to r+200 μm, and a depth in a range from r+5 μm to r+200 μm, in which r (μm) is a diameter of the optical fiber.

10. The optical element housing package of claim 1, wherein a thickness of the frame body is in a range from 0.7 mm to 1.8 mm.

11. The optical element housing package of claim 2, wherein a thickness of the frame body is in a range from 0.7 mm to 1.8 mm.

12. The optical element housing package of claim 3, wherein a thickness of the frame body is in a range from 0.7 mm to 1.8 mm.

13. The optical element housing package of claim 1, wherein the part of the optical fiber which is located in the optical fiber introducing portion is exposed, and the bared core has its outer circumference coated with a plating film.

14. The optical element housing package of claim 2, wherein the part of the optical fiber which is located in the optical fiber introducing portion is exposed, and the bared core has its outer circumference coated with a plating film.

15. The optical element housing package of claim 3, wherein the part of the optical fiber which is located in the optical fiber introducing portion is exposed, and the bared core has its outer circumference coated with a plating film.

16. The optical element housing package of claim 1, wherein the frame body has an optical fiber supporting member bonded to the base body side surface thereof so as to be located below the optical fiber introducing portion.

17. The optical element housing package of claim 2, wherein the frame body has an optical fiber supporting member bonded to the base body side surface thereof so as to be located below the optical fiber introducing portion.

18. The optical element housing package of claim 3, wherein the frame body has an optical fiber supporting member bonded to the base body side surface thereof so as to be located below the optical fiber introducing portion.

19. The optical element housing package of claim 16, wherein the lid body includes a flange portion which is bonded to the top surface of the optical fiber supporting member.

20. The optical element housing package of claim 17, wherein the lid body includes a flange portion which is bonded to the top surface of the optical fiber supporting member.

21. The optical element housing package of claim 18, wherein the lid body includes a flange portion which is bonded to the top surface of the optical fiber supporting member.

22. An optical module comprising:
the optical element housing of claim 1;
an optical element placed on the placement portion;
an optical fiber inserted through the optical fiber introducing portion and subjected to brazing; and
a lid body brazed to the one surface of the frame body, for hermetically sealing the optical element and the optical fiber introducing portion.
